(19) United States
(12) Patent Application Publication
(10) Pub. No.: US 2004/0131757 A1
(43) Pub. Date: Jul. 8, 2004

(54) Apparatus for aligning dispenser and aligning method thereof

(75) Inventors: Sung-Su Jung, Daegu (KR); Yong-Keun Kwak, Gangwon-do (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 10/717,717

(22) Filed: Nov. 21, 2003

(30) Foreign Application Priority Data
Dec. 23, 2002 (KR) 82677/2002

(51) Int. Cl. B05D 1/02; B05D 1/00; B05C 11/00

(52) U.S. Cl. 427/8; 427/421; 118/668; 118/669

(57) ABSTRACT

An apparatus for aligning a dispenser includes: a table that can move horizontally in forward/backward and left/right directions for receiving a substrate of at least one liquid crystal display panel; first and second dummy aligning plates on the table with a certain space therebetween; a syringe for supplying a sealant onto the first and second dummy aligning plates to form first and second alignment patterns; a first image camera for detecting an image of the first alignment pattern; a second image camera for detecting an image of the second alignment pattern; and an alignment controller for aligning the image of the first image camera with a first reference position and the image of the second image camera with a second reference position.

This application claims the benefit of the Korean Application No. P2002-082677 filed in Korea on Dec. 23, 2002, which is hereby incorporated by reference.

### BACKGROUND OF THE INVENTION

1. Field of the Invention

The present invention relates to an apparatus for aligning a dispenser and aligning method thereof, and more particularly, to an apparatus for aligning a dispenser and aligning method thereof for forming a seal pattern.

2. Discussion of the Related Art

In general, a liquid crystal display device is a display device where data signals according to picture information are individually supplied to liquid crystal cells arranged in a matrix form. Light transmittance of the liquid crystal cells is controlled in accordance with the data signals to display a desired picture. The liquid crystal display device includes a liquid crystal display panel where the liquid crystal cells are arranged in a matrix form, and a driver integrated circuit (IC) for driving the liquid crystal cells. The liquid crystal display panel includes a color filter substrate and a thin film transistor array substrate attached to each other. The liquid crystal display panel further includes a liquid crystal layer between the color filter substrate and the thin film transistor array substrate.

Data lines and gate lines are formed on the thin film transistor array substrate of the liquid crystal display panel cross each other at right angles so as to define liquid crystal cells. The data lines transmit a data signal supplied from the data driver integrated circuit to the liquid crystal cells. The gate lines transmit a scan signal supplied from the gate driver integrated circuit to the liquid crystal cells. At an end portion of each of the data lines and the gate lines, a data pad and a gate pad are respectively provided in which data signals and scan signals are respectively applied from the data driver integrated circuit and the gate driver integrated circuit. The gate driver integrated circuit sequentially supplies a scan signal to the gate lines so that the liquid crystal cells arranged in the matrix form can be sequentially selected line by line while a data signal is supplied to the selected line of the liquid crystal cells from the data driver integrated circuit.

A common electrode and a pixel electrode are respectively formed on the inner side of the color filter substrate and the thin film transistor array substrate for applying an electric field to the liquid crystal layer of a liquid crystal cell. More particularly, a pixel electrode is respectively formed in each liquid crystal cell on the thin film transistor array substrate, while the common electrode is integrally formed across the entire surface of the color filter substrate. Therefore, by controlling a voltage applied to the pixel electrode while a voltage is applied to the common electrode, light transmittance of the liquid crystal cells can be individually controlled. To control the voltage applied to the pixel electrode by liquid crystal cells, a thin film transistor is formed in each liquid crystal cell and used as a switching device.

FIG. 1 is a plane view of the unit liquid crystal display panel formed by a thin film transistor array substrate and a color filter substrate according to the related art. As shown in FIG. 1, the liquid crystal display panel 100 includes an image display part 113 where the liquid crystal cells are arranged in a matrix form, a gate pad part 114 connected to the gate lines of the image display part 113, and a data pad part 115 connected to the data lines of the image display part 113. The gate pad part 114 and the data pad part 115 are formed along an edge region of the thin film transistor array substrate 101, which does not overlap with the color filter substrate 102. The gate pad part 114 supplies a scan signal from the gate driver integrated circuit to the gate lines of the image display part 113, and the data pad part 115 supplies image information from the data driver integrated circuit to the data lines of the image display part 113.

Data lines to which image information is applied and gate lines to which a scan signal is applied are provided on the thin film transistor array substrate 101. The data lines and the gate lines cross each other. Additionally, a thin film transistor for switching the liquid crystal cells is provided at each crossing of the data lines and the gate lines. A pixel electrode for driving the liquid crystal cells is connected to the thin film transistor and provided on the thin film transistor array substrate 101. A passivation film for protecting the pixel electrode and the thin film transistor is formed at the entire surface of the thin film transistor array substrate 101.

Color filters are provided on the color filter substrate 102 for each cell region. The color filter are separated by a black matrix. A common transparent electrode is also provided on the color filter substrate 102.

A cell gap is formed by a spacer between the thin film transistor array substrate 101 and the color filter substrate 102. A seal pattern 116 isformed along an outer edge of the image display part 113. The thin film transistor array substrate 101 and the color filter substrate 102 are attached by the seal pattern 116 to thereby form a unit liquid crystal display panel.

In fabricating the unit liquid crystal display panel, a method for simultaneously forming unit liquid crystal display panels on a large-scale mother substrate is generally used. Thus, a process is required for separating the unit liquid crystal display panels from the large-scale mother substrate. For example, a cutting process can be used on the mother substrate to separate the plurality of unit liquid crystal display panels formed thereon.

The seal pattern 116, as discussed above, has an opening. After the unit liquid crystal display panel is separated from the large-scale mother substrate, liquid crystal is injected through a liquid crystal injection opening to form a liquid crystal layer at the cell-gap, which separates the thin film transistor array substrate 101 and the color filter substrate 102. Then, the liquid crystal injection opening is sealed.

As mentioned above, the following steps are required to fabricate the unit liquid crystal display panel: the thin film transistor array substrate 101 and the color filter substrate 102 are separately fabricated on first and second mother substrates, the first and second mother substrates are attached in such a manner that a uniform cell-gap is maintained therebetween, the attached first and second mother substrates are cut into unit panels, and then liquid crystal is injected to the cell-gap between the thin film transistor array substrate 101 and the color filter substrate 102. In particular, the process of forming the seal pattern 116 along an outer edge of the image display part 113 is required to attach the thin film transistor array substrate 101 and the color filter substrate 102. The related art process of forming a seal pattern will now be described.

FIGS. 2A and 2B illustrate a screen printing method to form a seal pattern. As shown in FIGS. 2A and 2B, there are provided a screen mask 206 patterned so that a plurality of seal pattern forming regions is selectively exposed. A rubber squeegee 208 is used to selectively supply a sealant 203 to the substrate 200 through the screen mask 206 so as to simultaneously form a plurality of seal patterns 216A˜216F. The plurality of seal patterns 216A˜216F is formed along each outer edge of the image display parts 213A˜213F of the substrate 200 and liquid crystal injection openings 204A˜204F are respectively formed for each of the seal patterns 216A˜216F.

The screen printing method includes: applying the sealant 203 on the screen mask 206 with the seal pattern forming regions patterned thereon, forming the plurality of seal patterns 216A˜216F on the substrate 200 through printing with the rubber squeegee 208; and evaporating a solvent contained in the seal patterns 216A˜216F and leveling them. The screen printing method is widely used because it is an easy process. However, the screen printing method is disadvantageous in that sealant 203 is wasted because a lot of sealant is discarded after the squeegee 208 is drawn across the screen mask to form the plurality of seal patterns 216A˜216F. In addition, the screen printing method has a problem in that rubbing of an orientation film (not shown) formed on the substrate 200 can incur defects when the screen mask 206 and the substrate 200 come into contact with each other. These defects will degrade picture quality of the liquid crystal display device.

To overcome the shortcomings of the screen printing method, a seal dispensing method has been proposed. FIG. 3 is an exemplary view of a related art dispensing method for forming a seal pattern. As shown in FIG. 3, while a table 310 with the substrate 300 loaded thereon is moved in forward/backward and left/right directions, a plurality of seal patterns 316A˜316F are formed along each outer edge of image display parts 313A˜313F on the substrate 300 by applying a predetermined pressure to syringes 301A˜301C filled with a sealant. The seal patterns 316A˜316F are sequentially formed for each line of the image display parts 313A˜313F in a line by line fashion. In the seal dispensing method, since the sealant is selectively supplied to the region where the seal patterns 316A˜316F are to be formed, sealant waste is prevented. In addition, the syringes 301A˜301C do not contact the orientation film (not shown) of the image display part 313 of the substrate 300 so that the rubbed orientation film will not be damaged. Thus, picture quality of the liquid crystal display device will be maintained.

In the case that the plurality of seal patterns 316A˜316F are simultaneously formed on the substrate 300 loaded on the table 310 by using the syringes 301A˜301C, the dispenser for a liquid crystal display panel should be precisely aligned with the substrate 300 in order to accurately form the seal patterns 316A˜316F at desired positions. That is, if any of the dispensers are misaligned with the substrate 300, the seal patterns 316A˜316F may be formed within the image display parts 313A˜313F, rather than formed along the outer edges of the image display parts 313A˜313F formed on the substrate 300. Such a misaligned seal pattern will result in the generation of a defective liquid crystal display panel.

In order to align the dispenser with the substrate 300, a dummy substrate has been used in the related art, which will now be described with reference to FIGS. 4A to 4F. First, as shown in FIG. 4A, a dummy substrate 411 is loaded on the table 410. Next, as shown in FIG. 4B, the table 410 is moved to a predetermined position. A sealant is then supplied through a syringe 401A onto the dummy substrate 411 to form a vertically crossing first alignment pattern 412, and then, an image of the first alignment pattern 412 is detected through a first image camera 402A provided at the side of the syringe 401A for display through a display unit 420. The display unit 420 displays both the position of the first alignment pattern 412 and a first reference position.

Subsequently, as shown in FIG. 4C, the table 410 with the dummy substrate 411 loaded thereon is moved in forward/backward and left/right directions to be aligned such that the first alignment pattern 412 and the first reference position displayed on the display unit 420 coincide with each other. As shown in FIG. 4D, the table 410 is then moved to a different predetermined position, and the sealant is supplied through the syringe 401A on the dummy substrate 411 to form a vertically crossing second alignment pattern 413.

Thereafter, as shown in FIG. 4E, the table 410 is moved to a certain position, and an image of a second alignment pattern 413 is detected through a second image camera 402B and displayed through the display unit 420. The display unit 420 displays both the position of the second alignment pattern 413 and a second reference position. As shown in FIG. 4F, the second image camera 402B is moved in forward/backward and left/right directions to be aligned such that the position of the second alignment pattern 413 and the second reference position displayed on the display unit 420 coincide with each other.

After the dispenser is aligned by using the dummy substrate 411, the dummy substrate 411 is unloaded. A mother substrate (not shown) with a plurality of image display parts formed thereon is then loaded on the table 410. Subsequently, the seal patterns are formed along each outer edge of the image display parts through a plurality of the syringes.

As the size of a unit liquid crystal display panel becomes larger, the area of the mother substrate has also increased to fabricate the larger-scale unit liquid crystal display panels. The mother substrate for fabricating the liquid crystal display panel is practically the same as the dummy substrate 411 except that an operator is used for fabricating an actual liquid crystal display panel. Loading and unloading of the dummy substrate 411 is manually done by the operator. Thus, as the area of the dummy substrate 411 increases, it becomes more and more difficult to load and unload the dummy substrate 411, which can cause a delay in fabrication. Such a delay will slow the fabrication line and thus decrease productivity. In addition, loading and unloading a large-scale dummy substrate 411 manually increases the chances of damage, which increases fabrication cost. Moreover, since additional space is required for the operator to perform the manual loading and unloading of the dummy substrate 411, space use efficiency of a clean room is degraded and a facility expense is increased.

### SUMMARY OF THE INVENTION

Accordingly, the present invention is directed to an apparatus for aligning a dispenser and aligning method thereof that substantially obviates one or more of the problems due to limitations and disadvantages of the related art.

An object of the present invention is to provide an apparatus for aligning a dispenser and aligning method thereof that is capable of quickly and easily aligning a dispenser to form a seal pattern using the dispenser.

To achieve these and other advantages and in accordance with the purpose of the present invention, as embodied and broadly described herein, there is provided an apparatus for aligning a dispenser including: a table that can move horizontally in forward/backward and left/right directions for receiving a substrate of at least one liquid crystal display panel; first and second dummy aligning plates on the table with a certain space therebetween; a syringe for supplying a sealant onto the first and second dummy aligning plates to form first and second alignment patterns; a first image camera for detecting an image of the first alignment pattern; a second image camera for detecting an image of the second alignment pattern; and an alignment controller for aligning the image of the first image camera with a first reference position and the image of the second image camera with a second reference position.

In another aspect, there is also provided a method for aligning a dispenser including: loading first and second dummy aligning plates onto a table with a certain space therebetween; moving the table and supplying a sealant on the first dummy aligning plate through a syringe to form a first alignment pattern; detecting a first image of the first alignment pattern and aligning the first image with a first reference position; moving the table and supplying the sealant on the second dummy aligning plate through the syringe to form a second alignment pattern; and detecting a second image of the second alignment pattern and aligning the second image with a second reference position.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a plane view of the unit liquid crystal panel formed by a thin film transistor array substrate and a color filter substrate according to the related art.

FIGS. 2A and 2B illustrate formation of a seal pattern through a screen printing method in accordance with the related art.

FIG. 3 illustrates formation of a seal pattern through a seal dispensing method in accordance with the related art.

FIGS. 4A to 4F show sequential processes of a method for aligning a dispenser by using a dummy substrate in accordance with the related art.

FIG. 5 shows an apparatus for aligning a dispenser in accordance with an embodiment of the present invention.

FIGS. 6A to 6F show sequential processes of a method for aligning a dispenser by using the apparatus for aligning the dispenser of FIG. 5.

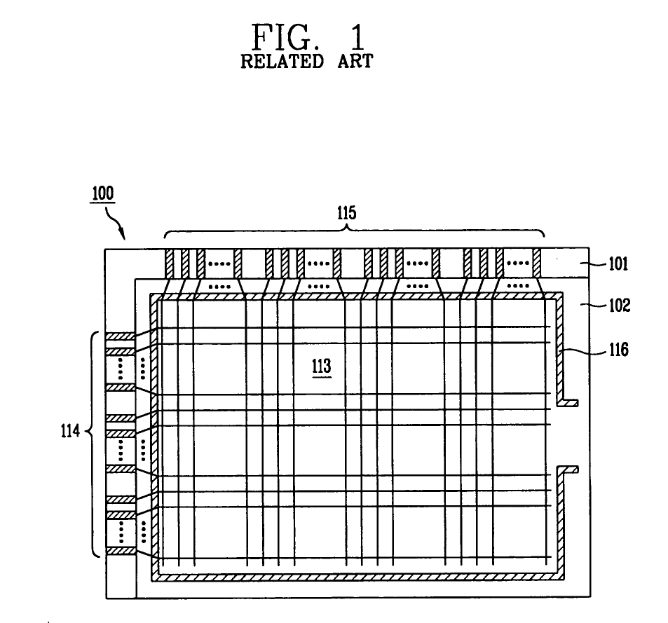

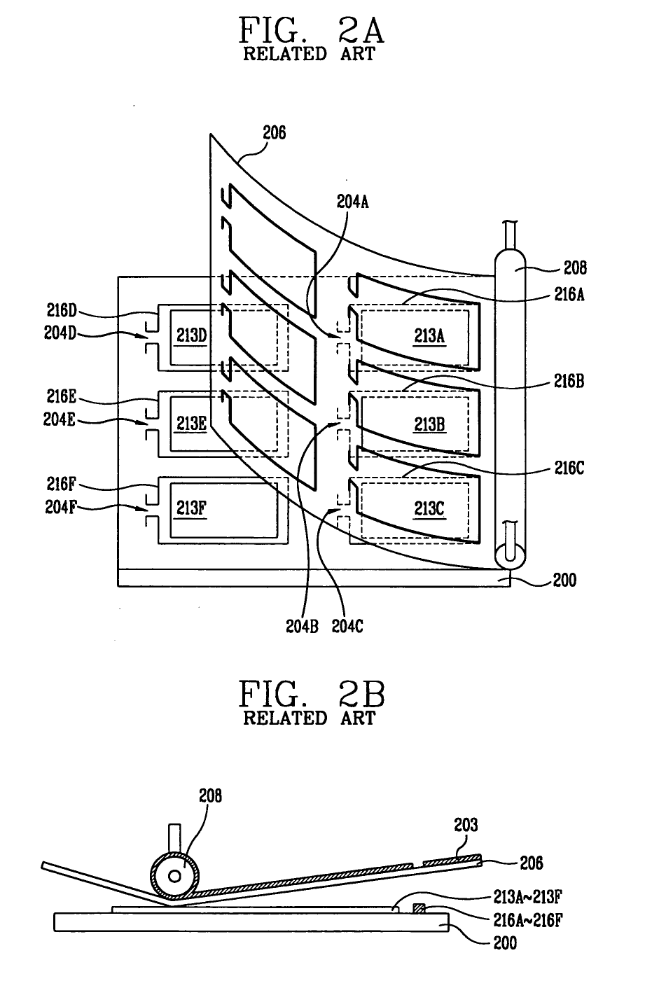

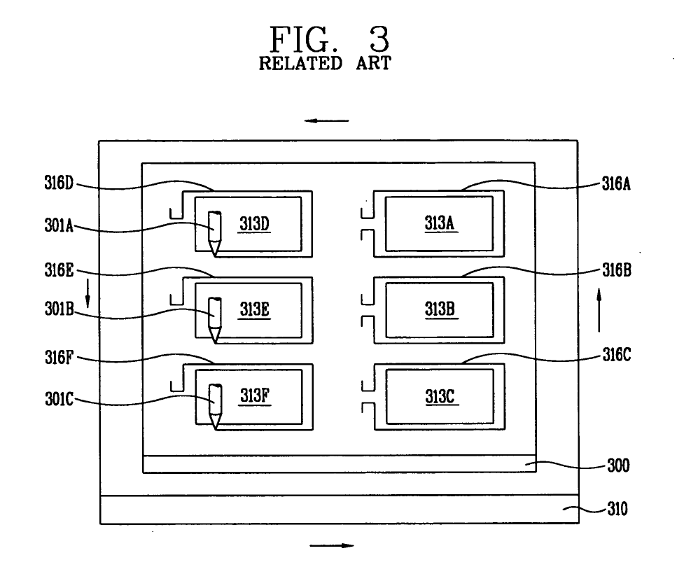

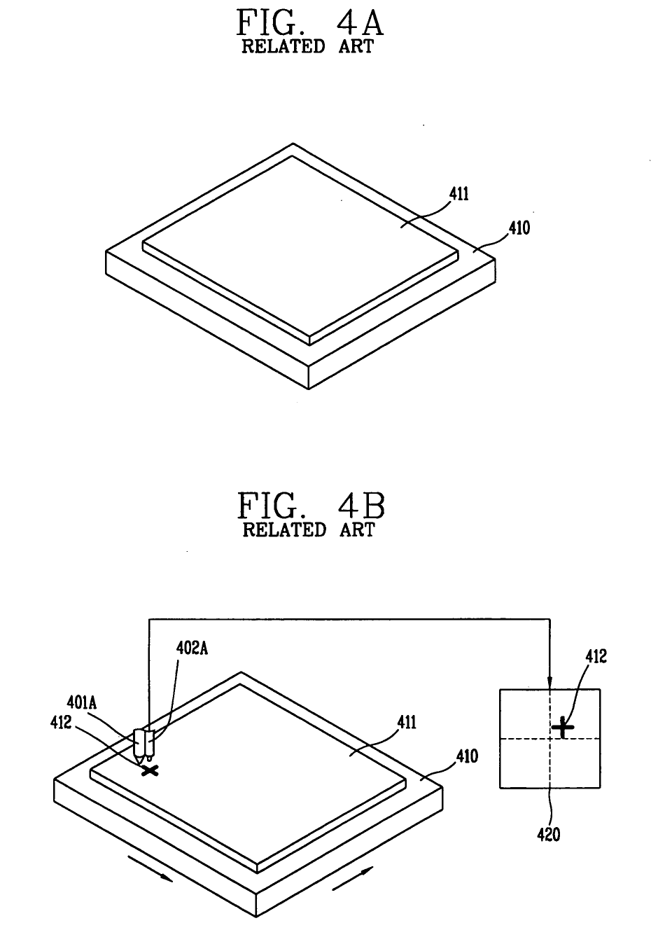

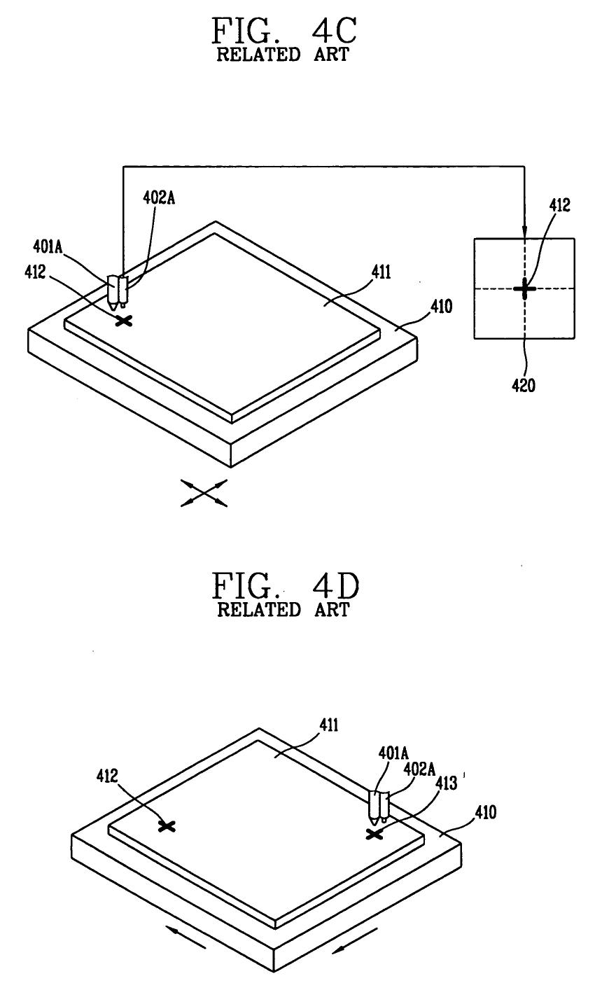

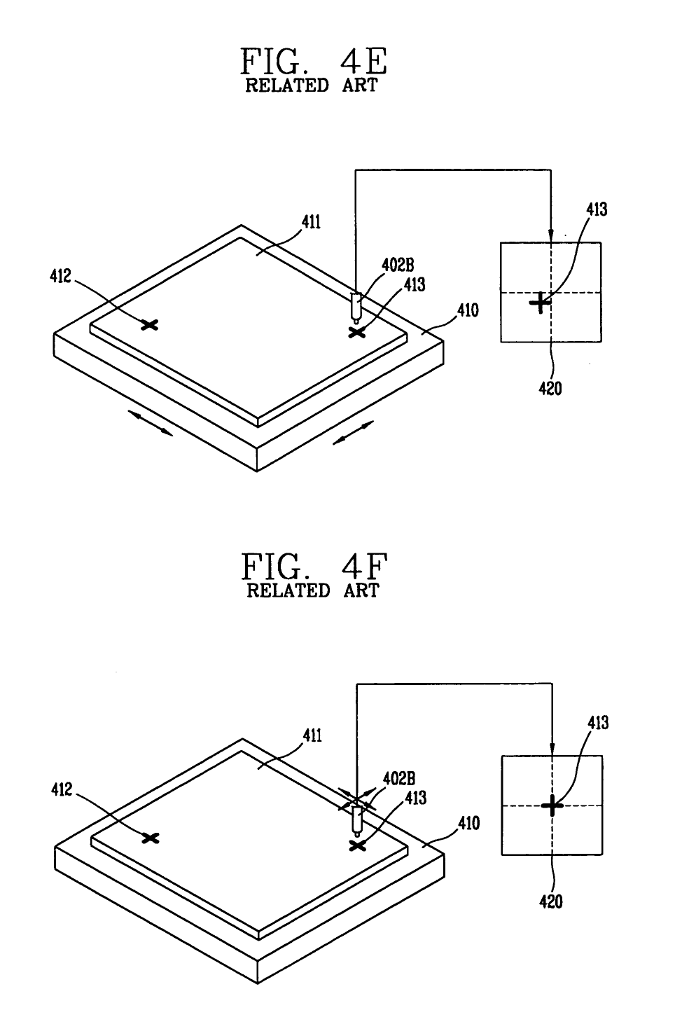

### DETAILED DESCRIPTION OF THE ILLUSTRATED EMBODIMENTS

Reference will now be made in detail to the illustrated embodiments of the present invention, examples of which are illustrated in the accompanying drawings.

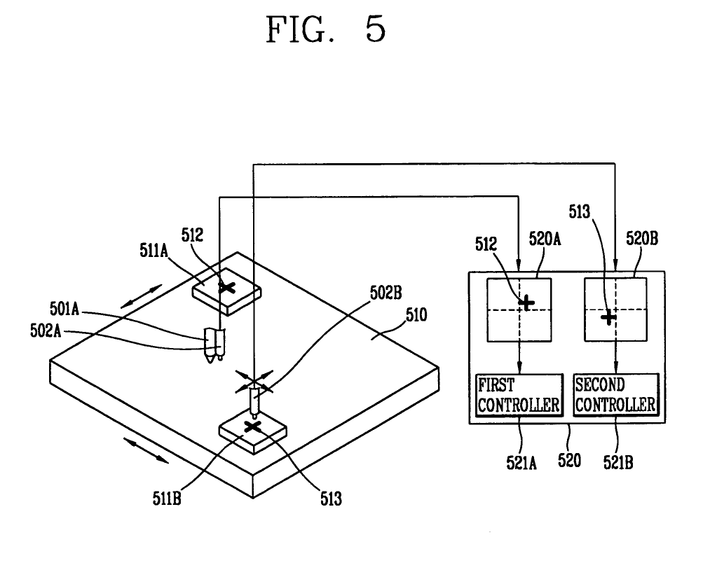

FIG. 5 shows an apparatus for aligning a dispenser in accordance with the present invention. As shown in FIG. 5, an apparatus for aligning a dispenser in accordance with an embodiment of the present invention includes: a table 510 that can move horizontally or parallel to the ground in forward/backward and left/right directions; first and second dummy aligning plates 511A and 511B loaded at predetermined positions on the table 510 with a certain space therebetween; a syringe 501A for supplying a sealant on the first and second dummy aligning plates 511A and 511B to form first and second alignment patterns 512 and 513 while the table 510 is moved in forward/backward and left/right directions; a first image camera 502A provided at the side of the syringe 501A for detecting an image of the first alignment pattern 512 formed on the first dummy aligning plate 511A; a second image camera 502B for detecting an image of the second alignment pattern 513 formed on the second dummy aligning plate 511B; an alignment controller 520 for moving the table 510 in forward/backward and left/right directions so as to align a first reference position and the first alignment pattern 512 detected by the first image camera 502A, and for moving the second camera 502B in forward/backward and left/right directions so as to align a second reference position and the second alignment pattern 513 as detected by the second image camera 502B. The first and second dummy aligning plates 511A and 511B may be formed of glass having a size smaller than the substrate. The substrate can be for one liquid crystal display panel or a mother substrate for a plurality of unit liquid crystal display panels. The first and second dummy aligning plates 511A and 511B may be fabricated having an area of about 100×100 mm, for example.

The alignment controller 520 includes: a first display unit 520A indicating the first reference position and the image of the first alignment patter 512 detected by the first image camera 502A; a second display unit 520B indicating the second reference position and the image of the second alignment pattern 513 detected by the second image camera 502B; a first controller 521A for moving the table 510 in forward/backward and left/right directions in order to align the image of the first alignment pattern 512 and the first reference position; and a second controller 521B for moving the second image camera 502B in forward/backward and left/right directions in order to align the image of the second alignment pattern 513 and the second reference position.

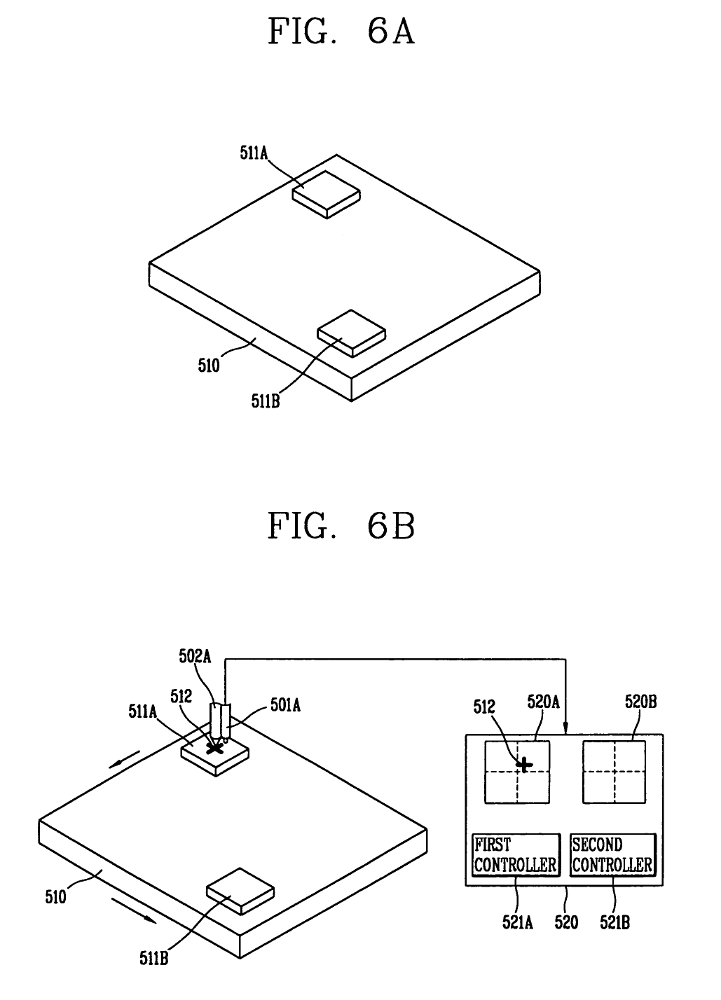

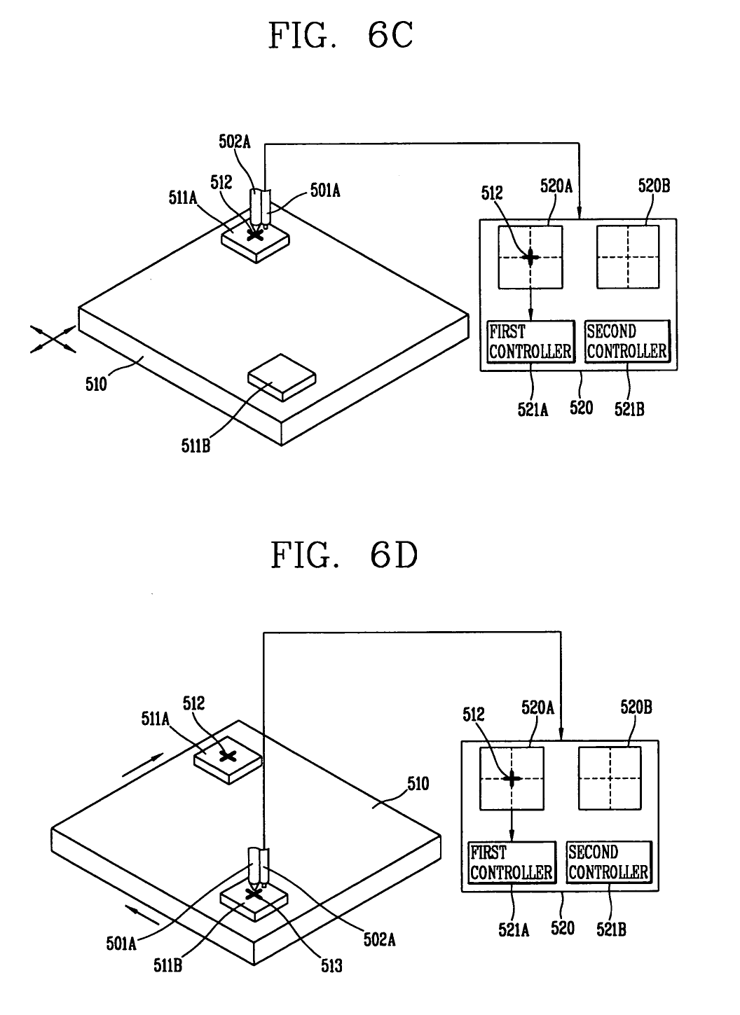

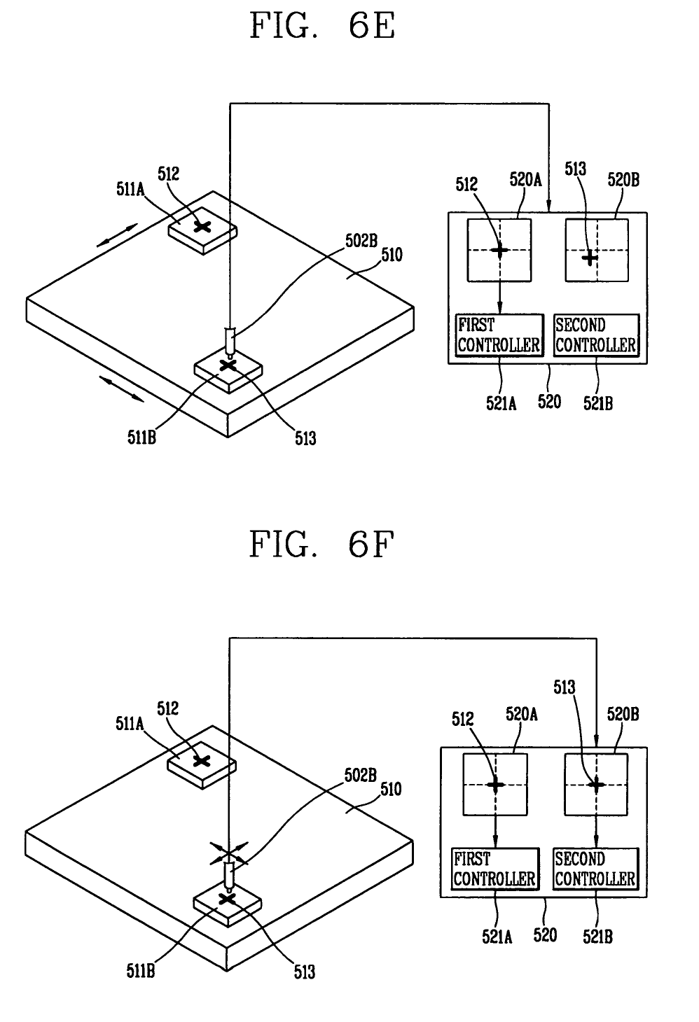

FIGS. 6A to 6F show sequential processes of a method for aligning a dispenser by using the apparatus for aligning the dispenser of FIG. 5, based on which a method for aligning a dispenser according to an embodiment of the present invention will now be described in detail. First, as shown in FIG. 6A, the first and second dummy aligning plates 511A and 511B are positioned at predetermined positions on the surface of the table 510 with a certain space therebetween. The certain space is a know distance between the first and second dummy aligning plates 511A and 511B of a known size. As mentioned above, the first and second dummy aligning plates 511A and 511B may be formed of, for example, glass and have an area of about 100×100 mm.

Next, as shown in FIG. 6B, the table 510 is moved to a certain position, the sealant is supplied through the syringe 501A on the first dummy aligning plate 511A to form the first alignment pattern 512. For example, the first alignment pattern can have two patterns that cross at a right angle. The certain position is a specific known position of the table. An image of the first alignment pattern 512 is detected through the first image camera 502A, which is provided at the side of the syringe 501A, and displayed through the first display unit 520A of the alignment controller 520. The first display unit 520A displays both the image of the first alignment pattern 512 and the first reference position.

As shown in FIG. 6C, the table 510 with the first and second dummy aligning plates 511A and 511B loaded thereon is moved in forward/backward and left/right directions using the first controller 521A of the alignment controller 520 in order to make the first alignment pattern 512 and the first reference position displayed on the first display unit 520A coincide with each other. Then, as shown in FIG. 6D, the table 510 is moved to a certain different position and the sealant is supplied through the syringe 501A onto the second dummy aligning plate 511B to form the second alignment pattern 513. For example, the second alignment pattern can have two patterns that cross at a right angle. Thereafter, as shown in FIG. 6E, the table 510 is moved in forward/backward and left/right directions so that the second dummy aligning plate 511B is positioned at a lower side of the second image camera 502B in order to detect an image of the second alignment pattern 513 through the second image camera 502B and display it through the second display unit 520B of the alignment controller 520. The second display unit 520B displays both the image of the second alignment pattern 513 and the second reference position.

As shown in FIG. 6F, the second image camera 502B is moved in forward/backward and left/right directions through the second controller 521B of the alignment controller 520, to make the image of the second alignment pattern 513 and the second reference position displayed on the second display unit 520 coincide with each other. After the dispenser is aligned by using the first and second dummy aligning plates 511A and 511B, the first and second dummy plates 511A and 511B are unloaded, and a mother substrate (not shown) with the plurality of image display parts formed thereon is loaded onto the table 510 to form the seal patterns along each outer edge of the image display parts using a plurality of syringes.

The seal patterns may be formed in various forms according to the method of forming a liquid crystal layer of a liquid crystal display panel. That is, in case that a liquid crystal layer is formed in a vacuum injection method, the seal pattern is formed in patterns with its one side opened to form a liquid crystal injection opening. On the other hand, if the liquid crystal layer is formed using a dropping method where liquid crystal is dropped onto the thin film transistor array substrate or color filter substrate of the liquid crystal display panel, the seal pattern is formed in a closed pattern.

As stated above, according to the apparatus for aligning the dispenser and the method for aligning the dispenser according to embodiments of the present invention, even though the area of a mother substrate is increased to fabricate a plurality of large-scale liquid crystal display panels, seal patterns may be formed on the mother substrate by using a plurality of the syringes that are aligned with first and second dummy aligning plates 511A and 511B that each have an area smaller by a few times to scores of times than the substrate.

Since the operator may simply perform loading and unloading of the first and second dummy aligning plates 511A and 511B because they have such a small area, the aligning process may quickly proceed and the first and second dummy aligning plates 511A and 511B can be handled easily with a decreased chance of damaging the first and second dummy aligning plates 511A and 511B. In addition, loading and unloading of the first and second dummy aligning plates 511A and 511B having such small sizes do not require a lot of space so that space efficiency of the clean room may be improved.

As so far described, the apparatus for aligning the dispenser and the method for aligning the dispenser of the present invention have the following advantages. Even though the area of the substrate for fabricating a large-scale liquid crystal display panel increases, dispensers may be precisely aligned by loading the first and second dummy aligning plates with an area smaller by a few times to scores of times than the substrate. Accordingly, thanks to the easy loading and unloading of the first and second dummy aligning plates with the small area, the aligning process quickly proceeds with improved productivity. Also, since damage to the first and second dummy aligning plates is prevented, fabrication costs may be reduced. In addition, loading and unloading of the first and second dummy aligning plates having such a small size improves the space use efficiency of the clean room.

It will be apparent to those skilled in the art that various modifications and variations can be made in the apparatus for aligning dispenser and aligning method thereof of the present invention without departing from the spirit or scope of the inventions. Thus, it is intended that the present invention covers the modifications and variations of this invention provided they come within the scope of the appended claims and their equivalents.

What is claimed is:

1. An apparatus for aligning dispenser, comprising:
a table that can move horizontally in forward/backward and left/right directions for receiving a substrate of at least one liquid crystal display panel;
first and second dummy aligning plates on the table with a certain space therebetween;
a syringe for supplying a sealant onto the first and second dummy aligning plates to form first and second alignment patterns;
a first image camera for detecting an image of the first alignment pattern;
a second image camera for detecting an image of the second alignment pattern; and
an alignment controller for aligning the image of the first image camera with a first reference position and the image of the second image camera with a second reference position.

2. The apparatus of claim 1, wherein the first and second dummy aligning plates are formed of glass smaller in area by a few times to scores of times than the substrate.

3. The apparatus of claim 2, wherein the substrate is a mother substrate having a plurality of unit liquid crystal display panels thereon.

4. The apparatus of claim 1, wherein the first and second dummy aligning plates have an area of about 100×100 mm.

5. The apparatus of claim 1, wherein the first image camera is provided on a side of the syringe.

6. The apparatus of claim 1, wherein the first and second aligning patterns have a horizontal pattern and a vertical pattern, which intersect at a right angle.

7. The apparatus of claim 1, wherein the alignment controller aligns the image of the first image camera with the first reference position by moving the table.

8. The apparatus of claim 1, wherein the alignment controller aligns the image of the second image camera with the second reference position by moving the second image camera.

9. The apparatus of claim 1, wherein the first and second dummy aligning plates are at predetermined positions on the table.

10. The apparatus of claim 1, wherein the alignment controller comprises:
a first display unit displaying the image of the first alignment pattern detected by the first image camera and the first reference position;
a second display unit displaying the image of the second alignment pattern detected by the second image camera and the second reference position;
a first controller for moving the table in forward/backward and left/right directions so as to align the image of the first alignment pattern and the first reference position; and
a second controller for moving the second image camera in forward/backward and left/right directions so as to align the image of the second alignment pattern and the second reference position.

11. A method for aligning a dispenser, comprising:
loading first and second dummy aligning plates onto a table with a certain space therebetween;
moving the table and supplying a sealant on the first dummy aligning plate through a syringe to form a first alignment pattern;
detecting a first image of the first alignment pattern and aligning the first image with a first reference position;
moving the table and supplying the sealant on the second dummy aligning plate through the syringe to form a second alignment pattern; and
detecting a second image of the second alignment pattern and aligning the second image with a second reference position.

12. The method of claim 11, wherein the table is moved to align the image of the first alignment pattern and the first reference position.

13. The method of claim 11, wherein the second image camera is moved to align the image of the second alignment pattern and the second reference position.

14. The method of claim 11, wherein loading first and second dummy aligning plates onto the table with the certain space therebetween includes positioning the first and second dummy aligning plates at predetermined positions on the table.

15. The method of claim 11, wherein moving the table and supplying a sealant on the first dummy aligning plate through a syringe to form a first alignment pattern includes moving the table to a first certain position.

16. The method of claim 11, wherein moving the table and supplying the sealant on the second dummy aligning plate through the syringe to form the second alignment pattern includes moving the table to a second certain position.
